(19) United States
(12) Patent Application Publication
(10) Pub. No.: US 2007/0257642 A1
(43) Pub. Date: Nov. 8, 2007

(54) Battery cell monitoring and balancing circuit

(76) Inventors: Sean Xiao, Shanghai (CN); Kevin Sheng, Shanghai (CN); Guoxing Li, Sunnyvale, CA (US); Liusheng Liu, San Jose, CA (US)

Correspondence Address: MURABITO, HAO & BARNES, LLP, TWO NORTH MARKET STREET, THIRD FLOOR, SAN JOSE, CA, 95113, US

(21) Appl. No.: 11/789,530

(22) Filed: Apr. 24, 2007

Related U.S. Application Data
(63) Continuation-in-part of application No. 11/459,473, filed on Jul. 24, 2006.
Application No. 11/459,473 is a division of application No. 10/464,973, filed on Jun. 19, 2003, now Pat. No. 7,081,737.

(51) Int. Cl. H02J 7/00

(52) U.S. Cl. 320/134

(57) ABSTRACT

A monitoring circuit for monitoring a plurality of battery cells of a battery pack includes a plurality of temperature sensors, an analog to digital converter (ADC) and a processor. The plurality of temperature sensors is used for sensing temperatures of the plurality of battery cells and outputting a plurality of analog temperature voltage signals representative of the temperature of the plurality of battery cells. The analog to digital converter (ADC) is adapted to receive the plurality of analog temperature voltage signals and to convert each of the plurality of analog temperature voltage signals to a plurality of individual digital signals. The processor is adapted to generate an alert signal when an individual digital signal is not within a predetermined range.

### CROSS REFERENCE TO PROVISIONAL APPLICATION

This application is a continuation-in-part application of U.S. patent application Ser. No. 11/459,473 filed Jul. 24, 2006 entitled “Battery Cell Monitoring and Balancing Circuit” which is a divisional application of U.S. patent application Ser. No. 10/464,973 filed Jun. 19, 2003 entitled “Battery Cell Monitoring and Balancing Circuit”.

### TECHNICAL FIELD

The present invention relates to a battery cell monitoring and balancing circuit, and in particular to a battery cell monitoring and balancing circuit that directly digitizes analog battery cell voltage levels into associated digital signals and uses such digital signals to make intelligent protection and balancing decisions.

### BACKGROUND ART

Multi-cell rechargeable batteries are utilized in a variety of applications because of their high voltage delivery capacity. Such applications include, but are not limited to, electronic devices such as laptops, cellular phones, personal digital assistants, and the like. Certain types of battery cells, e.g., lithium ion cells, can be hazardous if charged significantly above their normal charge range or discharged below their normal charge range. As such, a typical monitoring and protection circuit may utilize a switch network to transfer voltage charges to a capacitor. Voltage on the capacitor then represents the battery cell voltage and may then be provided to a plurality of comparators for comparing the voltage to various threshold levels such as over voltage and under voltage levels.

There are several drawbacks to such an arrangement. First, such an arrangement may provide for unreliable voltage measurements. For instance, if the current through a particular cell is not constant or the cell voltage fluctuates because of the internal resistance of the cell or some other factors, the sampled voltage may not be truly indicative of the voltage on the cell. As such, corrective measures may be taken based on such erroneous measurements.

Second, the threshold levels such as over voltage and under voltage are not easily adjustable. This is an issue since different battery pack types and different manufacturers for the same battery pack type may require different over and under voltage thresholds. For example, one battery pack manufacture may require a 3.0 volt under voltage threshold while another may require 2.5 volts for the same battery pack type. Third, when the cells in one battery pack are unbalanced after many charging and discharging cycles, a traditional bleeding approach can be taken to balancing cells. But a bleeding decision is typically made only when the battery is near fully charged at the time of charging. Since bleeding current is typically limited in order to avoid excessive heat generation, bleeding takes a certain time interval. If more than one cell needs to be bled, there is simply not enough time in one charge cycle to accomplish this task.

Accordingly, there is a need in the art for a cell monitoring and balancing circuit that overcomes these and other deficiencies in the prior art.

### SUMMARY OF THE INVENTION

In one embodiment, there is provided a monitoring circuit for monitoring a plurality of battery cells of a battery pack comprising a plurality of temperature sensors, an analog to digital converter (ADC) and a processor. The plurality of temperature sensors is used for sensing temperatures of the plurality of battery cells and outputting a plurality of analog temperature voltage signals representative of the temperature of the plurality of battery cells. The analog to digital converter (ADC) is adapted to receive the plurality of analog temperature voltage signals and to convert each of the plurality of analog temperature voltage signals to an individual digital signal. The processor is adapted to generate an alert signal when the individual digital signal is not within a predetermined range.

### BRIEF DESCRIPTION OF THE DRAWINGS

Advantages of the present invention will be apparent from the following detailed description of exemplary embodiments thereof, which description should be considered in conjunction with the accompanying drawings, in which:

FIG. 1 is a simplified high level block diagram of an electronic device that may receive power from a battery pack having a plurality of battery cells, where the electronic device has a cell monitoring and balancing circuit according to one embodiment of the present invention.

FIG. 2 is a block diagram of a monitoring circuit that may be utilized in the electronic device of FIG. 1 according to one embodiment of the present invention.

FIG. 3A is a block diagram of a balancing circuit that may be utilized in the electronic device of FIG. 1 according to one embodiment of the present invention.

FIG. 3B is an exemplary plot of the discharge characteristics of two battery cells that may receive a pre-balancing signal from the balancing circuit of FIG. 3A according to one embodiment of the present invention.

FIG. 4 is a more detailed block diagram of an exemplary cell monitoring and balancing circuit consistent with the invention according to one embodiment of the present invention.

FIG. 5 is an exemplary circuit diagram of one bleeding circuit that may be utilized in the bleeding network circuit of FIG. 4 according to one embodiment of the present invention.

FIG. 6 is another simplified high level block diagram of an electronic device according to one embodiment of the present invention.

FIG. 7 is a block diagram of a balancing circuit that may be utilized in the electronic device of FIG. 6 according to one embodiment of the present invention.

FIG. 8 is another more detailed block diagram of an exemplary cell monitoring and balancing circuit according to one embodiment of the present invention.

FIG. 9 is an exemplary circuit diagram of one bleeding circuit that may be utilized in the bleeding network circuit of FIG. 8 according to one embodiment of the present invention.

### DESCRIPTION OF THE EMBODIMENT

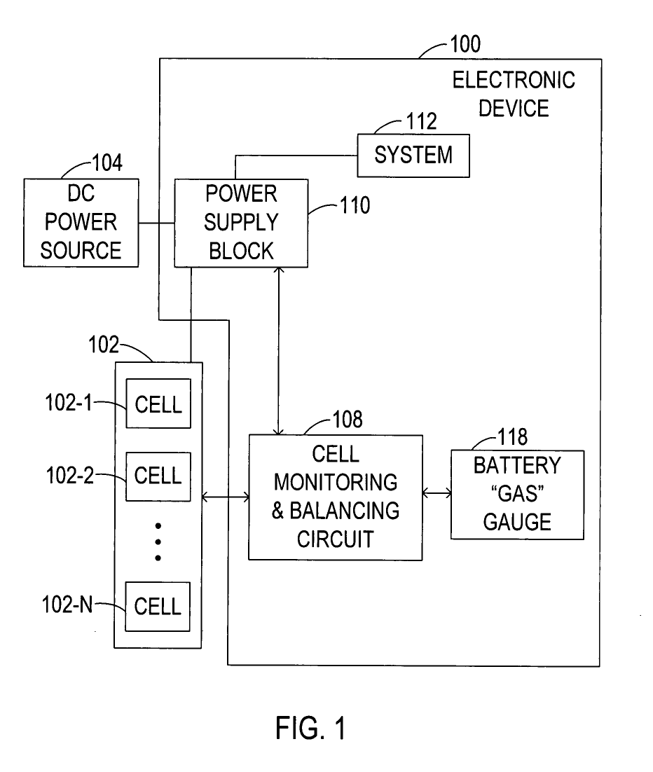

Referring to FIG. 1, a simplified block diagram of an electronic device 100 capable of being powered from a battery pack 102 or a DC power source 104 is illustrated. The battery pack 102 may contain a plurality of battery cells 102-1, 102-2, 102-n. The cell types may be of various rechargeable types known in the art such as lithium-ion, nickel-cadmium, nickel-metal hydride batteries, or the like.

If the electronic device 100 is a laptop computer it would include a variety of components known to those skilled in the art which are not illustrated in FIG. 1. For example, the laptop may include an input device for inputting data to the laptop, a central processing unit (CPU) or processor, for example a Pentium processor available from Intel Corporation, for executing instructions and controlling operation of the laptop, and an output device, e.g., a LCD or speakers, for outputting data from the laptop.

To recharge the battery pack 102 and/or supply power to the system 112, a DC power source 104 may be coupled to the device 100. The DC power source 104 may be an AC/DC adapter which is configured to receive conventional 120 volts AC from a wall outlet and convert it to a DC output voltage. The DC power source 104 may also be a DC/DC adapter such as a “cigarette lighter” type adapter configured to plug into that type of socket. Such a DC power source 104 is illustrated in FIG. 1 as separate from the device 100, but in other embodiments it may be built into some devices. The electronic device 100 may also have a power supply block 110. In general, the power supply block 110 includes various components to monitor, control, and direct power from each power source 102, 104 to each other and to the system 112 of the electronic device 100 under various conditions.

Advantageously, the electronic device 100 includes a cell monitoring and balancing circuit 108 as further detailed herein. The cell monitoring and balancing circuit 108 is shown separate from the power supply block 110 for clarity, but it may be included as part of the power supply block 110. The cell monitoring and balancing circuit 108 may function as a monitoring circuit, a balancing circuit, or both as further detailed herein. The cell monitoring and balancing circuit 108 provides digital signals representative of the voltage level of each cell 102-1, 102-2, 102-n to various components of the device such as a battery gas gauge 118. The battery gas gauge may utilize such signals to provide an output signal representative of the remaining useful life of the battery pack 102.

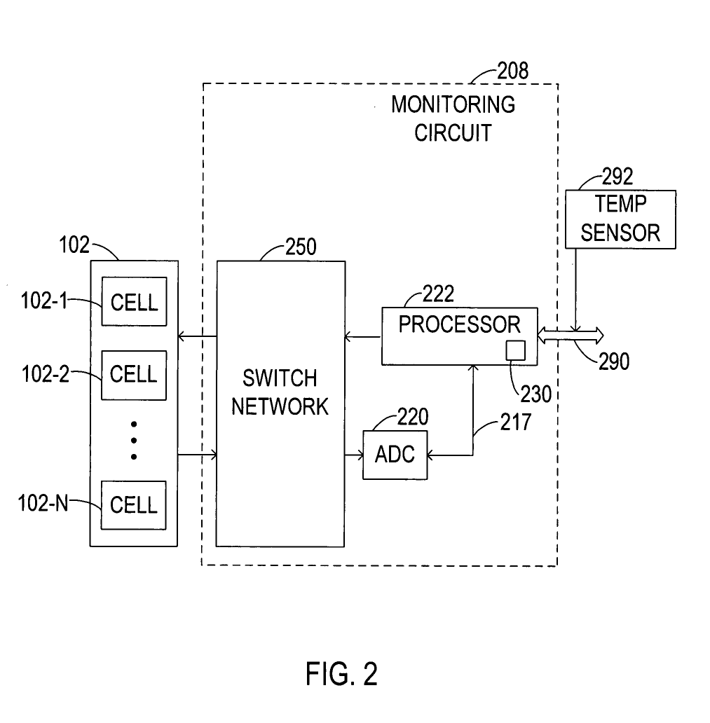

Turning to FIG. 2, a block diagram of an exemplary monitoring circuit 208 that may be utilized as the monitoring portion of the cell monitoring and balancing circuit 108 of FIG. 1 is illustrated. The monitoring circuit 208 generally includes an analog to digital converter (ADC) 220 and a processor 222. The ADC 220 is configured to accept an analog voltage signal from each of the battery cells 102-1, 102-2, 102-n and convert each to a digital signal. The processor 220 is configured to receive each digital signal and provide a safety alert signal based on at least one of the digital signals.

Advantageously, the ADC 220 may function as an “averaging” type ADC to take an “average” reading of the voltage of each battery cell 102-1, 1-2-2, 102-n such that transient deviations from normal readings will not adversely impact the quality of the digital signal representation of the analog signal. For example, such transient deviations could include voltage spikes or other rapid voltage fluctuations that can occur due to a number of factors including varying charging currents or load currents passing through the internal resistance of the cells.

The ADC 220 may include one or more various types of ADCs to function as an averaging type ADC. For instance, the ADC 212 may include single-slope or dual-slope integrating type ADC or a sigma-delta type ADC. Such a sigma-delta type ADC generally includes an analog modulator portion that essentially digitizes an input analog signal at very high sampling frequency equal to Fs×OSR, where Fs is the Nyquist Frequency and OSR is the over sampling ratio to the Nyquist Frequency. The outputs from this over sampling may be combined in groups and the groups may be averaged. An analog signal representing the voltage of any particular battery cell 102-1, 102-2, 102-n may thus be sampled many times, e.g., in the thousands of times in some instances. As such, a few incorrect samplings of transient deviations will have little effect on the average signal converted by the averaging type ADC 220 to an associated digital signal.

In addition, the ADC 220 may also have an adjustable resolution depending on a particular need. For instance, the processor 222 may instruct the ADC 220 via data path 217 to utilize a desired resolution level for a particular conversion of an analog signal from a particular battery cell 102-1, 102-2, 102-n to an associated digital signal. The resolution may be adjusted to a relatively higher resolution in situations where there is more sensitivity to the analog voltage measurement. For example, such a situation requiring higher resolution may be for open circuit voltage detection.

In contrast, resolution may be adjusted to a relatively lower resolution in situations where there is less sensitivity to the analog voltage measurement. For example, such a situation requiring lower resolution may be for under-voltage detection. The lower the resolution, the less time is needed to complete one valid analog to digital conversion. In one of many examples, a relatively higher resolution may require 15 bits of data while the relatively lower resolution may only require 10 bits of data. Those skilled in the art will recognize the actual number of bits may vary depending on the particular requirements for the digital data and the resolution capabilities of the ADC 220.

To achieve a desired resolution value, the ADC 220 may be of any type of ADC that can adjust resolution upon direction from the ADC control signal from the processor 222. For instance, the ADC 220 may be a sigma-delta type as earlier detailed. Such a sigma-delta modulator type can adjust resolution based, in part, on the OSR. In general, higher resolution can be obtained with a higher OSR.

The ADC 220 may also be a successive approximation type ADC. In general, a successive approximation type ADC conceptually uses a single comparator to make its conversion. If N bits of resolution are desired as indicated by the control signal from the processor 220, a successive approximation type ADC would make N comparator operations to achieve N bits of resolution. Other types of ADCs, and or combinations of various types of ADCs may be used in an ADC 220 consistent with the invention to achieve an adjustable resolution.

The processor 222 is configured to receive digital signals from the ADC 220 representative of the voltage level of each battery cell 102-1, 102-2, 102-n and to provide a safety alert signal based on at least one of the digital signals. The safety alert signal may be a charge alert signal or a discharge alert signal.

During charging of the battery pack 102 by the DC power source 104, it is important to monitor the voltage level of each cell in order to protect against over voltage conditions. This is because certain types of electrolyte battery cells, such as lithium ion cells, are susceptible to damage if charged above their normal threshold level. As such, the processor 222 sends a charge alert signal if the digital signals from the ADC 220 indicate that at least one of the cells 102-1, 102-2, 102-n has a voltage level greater than an over voltage threshold value over a predetermined time interval. As such, some preventative action may then be taken such as to stop charging. Alternatively, the processor 222 may also provide the charge alert signal if one of the digital signals from the ADC 220 indicates that one cell has a voltage level greater than the over voltage threshold level while the battery pack 102 is being charged.

During discharging of the battery pack 102, the monitoring circuit 208 may utilize a plurality of under voltage threshold levels to prevent damage to the cells and to provide adequate warnings to a user of an associated electronic device 100. For instance, the processor 222 may send a discharge alert signal if the digital signals from the ADC 220 indicate that at least one of the cells 102-1, 102-2, 102-n has a voltage level lower than an under voltage threshold value over a predetermined time interval while the battery pack 102 is being discharged. As such, some preventative action may then be taken such as to stop power supply from the battery pack. Alternatively, the processor 222 may also provide the discharge alert signal if one of the digital signals from the ADC 220 indicates that one cell has a voltage level less than the under voltage threshold level while the battery pack 102 is being discharged.

In addition to the under voltage threshold level, other under voltage threshold voltage levels greater than the under voltage threshold level may also be utilized by the processor 222 to provide advanced notice of a potentially impending low voltage condition. For instance, if the electronic device 100 is a laptop computer and the under voltage threshold level is reached without any notice to the user, a user may lose a significant amount of important unsaved data.

Therefore, a first under voltage threshold level may be programmed into and stored in any applicable memory device of the system 100. As the processor 222 receives digital signals from the ADC 220 representative of the voltage levels of each cell, the processor 222 can compare such voltage levels to the first under voltage threshold level. If the voltage level on one of the cells drops below such level, the processor 222 can provide an appropriate signal via path 290 to other components of the system 100. As such, an alert message may then be provided to a user of the electronic device 100. The first under voltage threshold level may be chosen based on the system 100 particulars including the time required to perform typical tasks and the power required for such tasks.

For instance, if the electronic device 100 is a laptop computer the first threshold level may be chosen high enough that upon notice of a low power condition (e.g., one cell of the cells 102-1, 102-2, 102-n has a voltage level less than the first threshold level) a user still has enough power and time to operate the laptop for an additional time period. Another second threshold level, which is less than the first threshold level, may also be utilized to indicate that a shorter time period is available to the user for proper operation. For instance, if the any cell voltage is less than the second threshold level, another alert signal may indicate to the user that there is likely only enough time for saving and shutting down of the laptop computer before the under voltage threshold level is reached and battery power to the system is halted.

Advantageously, all threshold levels are adjustable by the processor 222. For instance, the over and under voltage threshold level may be adjusted based on the particular type of cell utilized. The over and under voltage threshold values may be stored in any variety of electronic storage media in the device. For instance, the processor 222 may have internal registers 230 that could store such threshold levels.

In addition, the over and under voltage threshold level can be adjusted based on other parameters that affect the charging and discharging performance of the cells such as ambient temperature and age of the cells. Ambient temperature information may be provided to the processor 222 by a temperature sensor 292.

In addition, a sampling time interval is also adjustable by the processor 222. A sampling time interval includes that time period in which all cells are sampled once and a valid digital conversion is made by the ADC 220 for each cell. This enables the processor to sample the cells more frequently during certain conditions, e.g., during charging, when more frequent sampling is advantageous. This also enables the processor to sample the cells less frequently during other conditions, e.g., the battery pack 102 is in sleep or idle mode, when less frequent sampling is adequate. For example, such a sampling time interval may be once per minute when the battery pack is in sleep or idle mode. As such, the ADC 220 may also be placed in a sleep mode by the processor 222 in order to conserve energy when it is not needed to make a conversion.

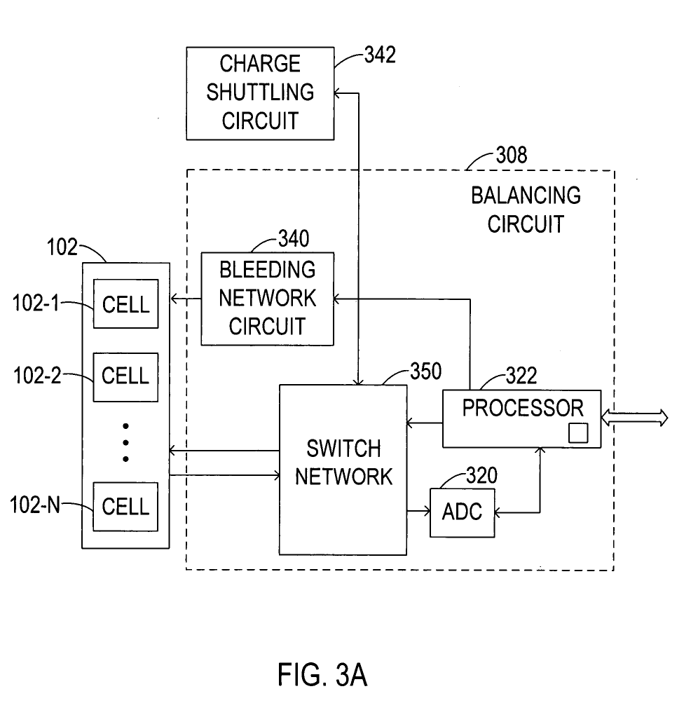

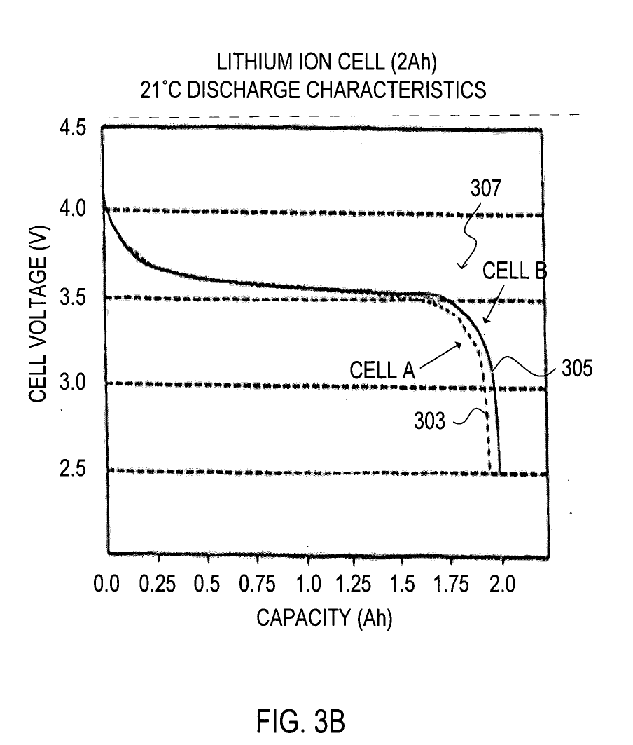

Turning to FIG. 3, a block diagram of an exemplary balancing circuit 308 is illustrated that may be utilized in the electronic device of FIG. 1. The balancing circuit 308 generally includes an ADC 320 and processor 322 as previously detailed with respect to FIG. 2. In addition, the processor 322 controls either the bleeding network circuit 340, the charge shuttling circuit 342, or both to balance voltage levels of the cells 102-1, 102-2, 102-n as further detailed herein.

The processor 322 receives associated digital signals from the ADC 320 as previously detailed that are representative of an accurate voltage reading for each cell 102-1, 102-2, 102-n. As such, the processor 322 not only knows which cell has the highest voltage level and the lowest voltage level, it also knows the magnitude of the voltage difference between such cells and the voltage level of each cell. The processor 322 utilizes this information from the ADC 320 to make intelligent decisions regarding cell balancing as detailed herein that result in accurate and fast cell balancing.

First, cell balancing decisions may be made at any time (during charging mode, discharging mode, or even during idle mode) whenever there is a voltage difference between the highest voltage cell and the lowest voltage cell that is greater than some battery cell balance threshold. During charging, cell balancing is useful to control the cells with the higher voltage levels to enable the lower voltage level cells time to catch up. Since battery charging is typically limited by any one cell reaching its end of charge voltage level, this enables each cell to approach its end of cell voltage level. Otherwise, a cell that reached its end of voltage level charge quickly would prevent other cells from being more fully charged.

Since the processor 322 is repeatedly receiving updated accurate voltage information of each cell 102-1, 10202, 102-n from the ADC 320, it can instruct the bleeding network circuit 340 to conduct appropriate cell bleeding or it can instruct the charge shuttling circuit 342 to conduct appropriate charge transfers as soon as it detects a voltage difference between a higher voltage cell and a lower voltage cell is greater than a predetermined battery cell balance threshold.

Balancing can occur by providing a bleeding current to one or more of the cells having higher voltage levels during certain time intervals. Such time intervals may overlap such that bleeding for more than one cell may occur at similar times. In addition, the starting times for the bleeding of two or more cells can start at substantially the same time in order to speed up the bleeding process. Furthermore, cell bleeding can be adjusted based on the difference in voltage between the higher and lower voltage cells. As such, a first cell with a relatively higher voltage level may be bled by a higher bleeding current than a second cell with a voltage level slightly less than the first cell.

In general, the greater the difference between the higher voltage cell and lower voltage cell, the greater the bleeding current provided by the bleeding network circuit 340. The upper limit of such bleeding current is typically limited by heat dissipation concerns. Also, the less the difference between the higher voltage cell and the lower voltage cell, the less bleeding current is provided by the bleeding network circuit 340.

Balancing cell voltage levels can occur not only by bleeding the cells with the higher voltage levels, but also by shuttling charges from higher voltage cells to lower voltage cells. Such charge shuttling is controlled by the processor 322 which provides appropriate control signals to the switch network 350 to control the shuttling of charge from cells with higher voltage levels to cells with lower voltage levels by utilizing the charge shuttling circuit 342.

The processor 322 knows which one or more cells 102-1, 102-2, 102-n have higher voltage readings compared to the others due to the digital signals received from the ADC 320. As such, the processor 322 may direct the appropriate switches in the switch network 350 to close such that one or more cells with a higher voltage level transfers some charge level to the charge shuttling circuit 342. The processor 322 may then further direct appropriate switches in the switch network 350 to close to transfer charges from the charge shuttling circuit 342 to the cell with a lower voltage level. Such a charge transfer process stops when the processor 322 instructs such process to stop, e.g., when the processor knows that an appropriate balanced voltage level is obtained between appropriate cells.

The processor 322 may also provide a pre-balance signal to the bleeding network circuit 340 or the charge shuttling circuit 342 to start a balancing process before an imbalance exists. For instance, the processor 322 has each cell's voltage information in digital form and knows the cells voltage history. After one or more charging and discharging cycles, if the processor 322 notices that an imbalance always happens to one specific cell, e.g., if one cell has a lower voltage level towards the end of discharge, then the processor can start a balancing process before a noticeable voltage difference is even detectable.

For instance, turning to FIG. 3B, and exemplary plot of capacity (Ah) of a lithium ion cell at 21 degree Celsius versus cell voltage is illustrated for an exemplary Cell A 303 and Cell B 305. As illustrated, it is not until near the end of discharge near the voltage drop knee 307 that the voltage difference between Cell A and Cell B becomes appreciable. If balancing waited until such an appreciable voltage difference, then there is little time to perform balancing. If however, the processor 322 knows that cell A typically has a lower voltage than cell B towards the end of discharge from at least one prior discharge cycle, the processor 322 can start balancing for cell A early in its discharge cycle without waiting for the appreciable voltage difference to occur. For instance, the processor may instruct charges from Cell B and/or other cells to be transferred to the charge shuttling circuit 442 and then to Cell A early in the discharge mode. In this way, Cell A may be balanced with Cell B so that no appreciable voltage difference exists between the cells near their end of discharge cycle.

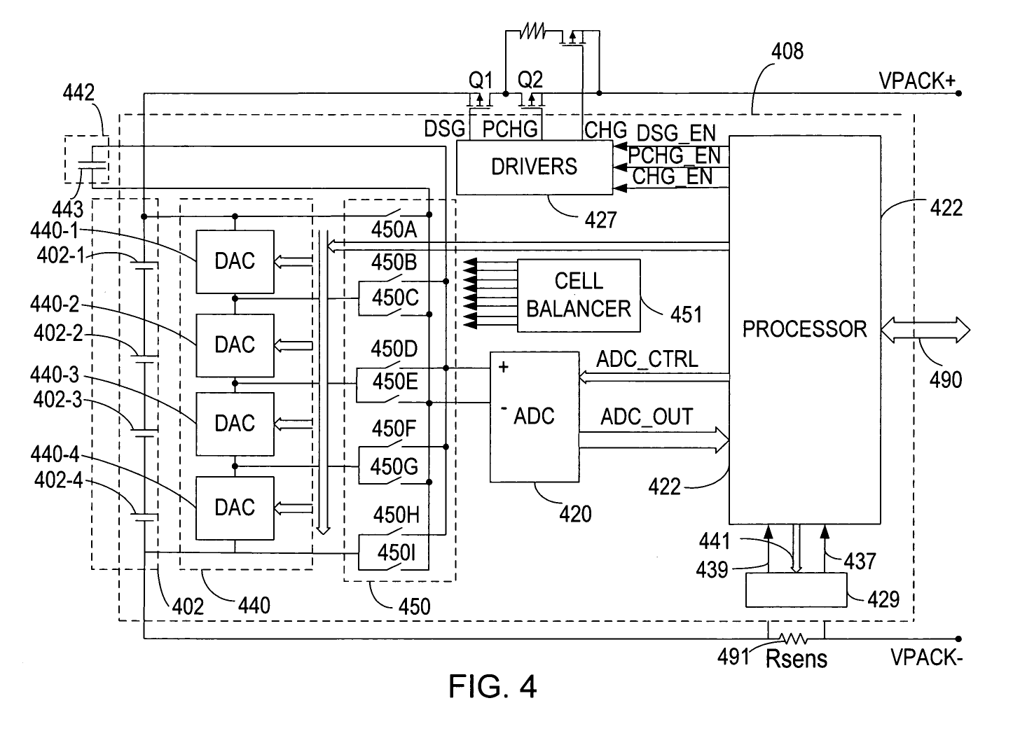

Turning to FIG. 4, an exemplary cell monitoring and balancing circuit 408 is illustrated. The cell monitoring and balancing circuit 408 includes the functionality of the monitoring circuit 208 of FIG. 2 and the balancing circuit 308 of FIG. 3. In general, the circuit 408 may include an ADC 420, a processor 422, a switch network control circuit 451, a switch network 450, a bleeding network circuit 440, a driver circuit 427, and a protection circuit 429.

Individual analog cell voltage levels for each cell of the battery pack 402 may be sampled directly through the switch network 450. The sampled analog signals may then be converted into associated digital signals by the ADC 420 as previously detailed. For instance, when the first cell 402-1 is to be sampled, the switches 450a and 450c of the switch network 450 close, while all other switches of the switch network 450 remain open. As such, the positive terminal of the first cell 402-1 is coupled through switch 450a to the positive input terminal of the ADC 420. Also, the negative terminal of the first cell 402-1 is coupled through switch 450c to the negative input terminal of the ADC 420. All switches of the switch network 450 will remain in these positions until a valid analog to digital conversion is completed by the ADC 420 over a given conversion time period for the first cell 402-1.

Similarly the second cell 402-2 (through closed switches 450b and 450e with other switches of the switch network 450 open), the third cell 402-3 (through closed switches 450d and 450g with other switches of the switch network 450 open), and the fourth cell 402-4 (through closed switches 450f and 450i with other switches of the switch network 450 open) may also be directly coupled to the ADC 420 in a like manner for direct sampling of each cell 402-2, 402-3, and 402-4.

The charge shuttling circuit 442 may include an energy storage element such as a transformer, inductor, or capacitor. In the illustrated embodiment, a capacitor 443 is utilized as the energy storage element. If charge shuttling among cells is directed by the processor 442, the appropriate switches 450a to 450g of the switch network 450 direct charges from one or more of the cells with the higher voltage to be temporarily stored in the capacitor 443. Such charges are then shuttled to a lower voltage cell by the appropriate switches of the switch network 450. The processor 422 controls the switch network 450 via the switch network control circuit 451.

An ADC 420 consistent with the invention may also be calibrated for each individual cell 402-1, 402-2, 402-3, and 402-4 in order to compensate for any offset. Such offset can be due to any number of factors such as different voltage gradients, and switching charge injection for different ADC cell channels. For instance, to calibrate the first cell 402-1, switches 450b and 450c would be closed with all other switches of the switch network 450 open. As such, the input terminals of the ADC 420 are connected to the virtual ground of the first cell 402-1. The ADC 420 would then convert such analog signal into an associated first offset digital signal. The first offset digital signal may then be stored in any available memory device.

Similarly, to calibrate the second cell 402-2, switches 450d and 450e would be closed. To calibrate the third cell 402-3, switches 450f and 450g would be closed. Finally, to calibrate the fourth cell 402-4, switches 450h and 450i would be closed. As such, four offset values for each associated cell 402-1, 402-2, 402-3, and 402-4 can be obtained and stored. When the ADC 420 is later converting an analog measurement for an associated cell, the processor 422 can instruct acquisition of offset-free data by subtracting the stored associated offset value for the associated cell. As such, accurate measurement of the analog signal from each cell is further promoted.

A protection circuit 429 may also be incorporated into the cell balance and monitoring circuit 408 in order to monitor the current flowing into (charging mode) or out of (discharging mode) the battery pack 402 for various power crisis conditions, e.g., over current or short circuit conditions, and alert the processor 422 of such conditions so that preventative action can be taken. For instance, a current sensing element such as sense resistor 491 may be coupled to the battery pack 402 to provide the protection circuit 429 with a signal representative of the current level to or from the battery pack as that current level varies. If the current level is greater than a first current threshold level, (e.g., the voltage drop across the sense resistor 491 is greater than the first current threshold level times the value of the sense resistor), then the protection circuit 429 provides an over current alert signal to the processor 422 via data path 437.

The current level may be greater than a second current threshold level, where the second current threshold level is greater than the first current threshold level. In this instance (e.g., the voltage drop across the sense resistor is greater than the second current threshold level times the value of the sense resistor), the protection circuit 429 provides a short circuit alert signal to the processor via data path 439.

In response to such control signals from the protection circuit 429, the processor 422 makes decisions and sends appropriate control signals such that appropriate power safety measures are taken. The processor 422 may provide an appropriate control signal to the switch driver 427 in order to drive the discharge switch Q1 open. Alternatively, the processor 422 may also provide a message to a host component via data path 490 such that some alternative component, e.g., a power management unit, may manage any necessary corrective action to ensure power supply safety.

The bleeding network circuit 440 may include a plurality of bleeding circuits 440-1, 440-2, 440-3, and 440-4 to provide an adjustable bleeding current to each associated cell 402-1, 402-2, 402-3, and 404-4 as previously detailed.

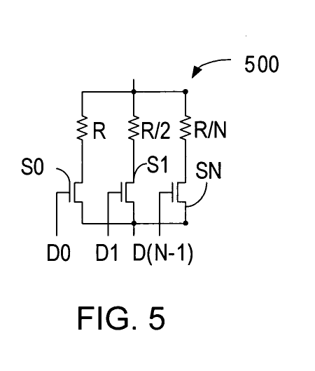

Turning to FIG. 5, one exemplary bleeding circuit 500 is illustrated. The bleeding circuit is responsive to a digital control signal from the processor 422 to control the bleeding current from the associated cell 402-1, 402-2, 402-3, and 404-4 as previously detailed. The bleeding circuit 500 may include a plurality of switches S0, S1, SN and an associated plurality of resistors R, R/2, and R/N. In one embodiment, the switches may be MOSFET type transistors having their control or gate terminal configured to receive the digital control signal from the processor 422. An N-bit digital control signal from the processor 422 may then dictate which switch S0, S1, SN turns ON and hence which resistor value R, R/2, or R/N is coupled in parallel with the associated battery cell 402-1, 402-2, 402-3, and 404-4.

If a large bleeding current is desired, the N-bit digital control signal from the processor 422 may instruct a switch, e.g., switch SN, to close such that a lower resistance value, e.g., resistor R/N, is coupled in parallel with the associated cell. As such, a larger bleeding current more quickly lowers the voltage level of the higher voltage cell. If a relatively smaller bleeding current is desired, the N-bit control signal from the processor 422 may instruct a switch, e.g., switch S1, to close such that a high resistance value, e.g., resistor R, is coupled in parallel with the associated cell. As such, a relatively smaller bleeding current is provided to more slowly lower the voltage level of a higher voltage cell.

The cell bleeding control signals from the processor 422 may also be provided to a battery gas gauge in order to provide such gauge with accurate cell bleeding information. For instance, a N-bit control signals provided to the cell bleeding circuits 440-1, 440-2, 440-3, 440-4 may also be provided to associated battery gas gauge. As such, the gauge also knows which cell 402-1, 402-2, 402-3, and 402-4 is being bled and the associated bleeding current level for each cell. Therefore, the gauge can make more reliable calculations to determine the remaining amount of battery life taking into account bleeding current levels for charging capacity calculations.

As earlier indicated, the present invention, although first described with reference to cell monitoring and balancing circuit which provides digital signals representative of the voltage level of each cell, the digital signals can also representative of temperature level of each cell and current level.

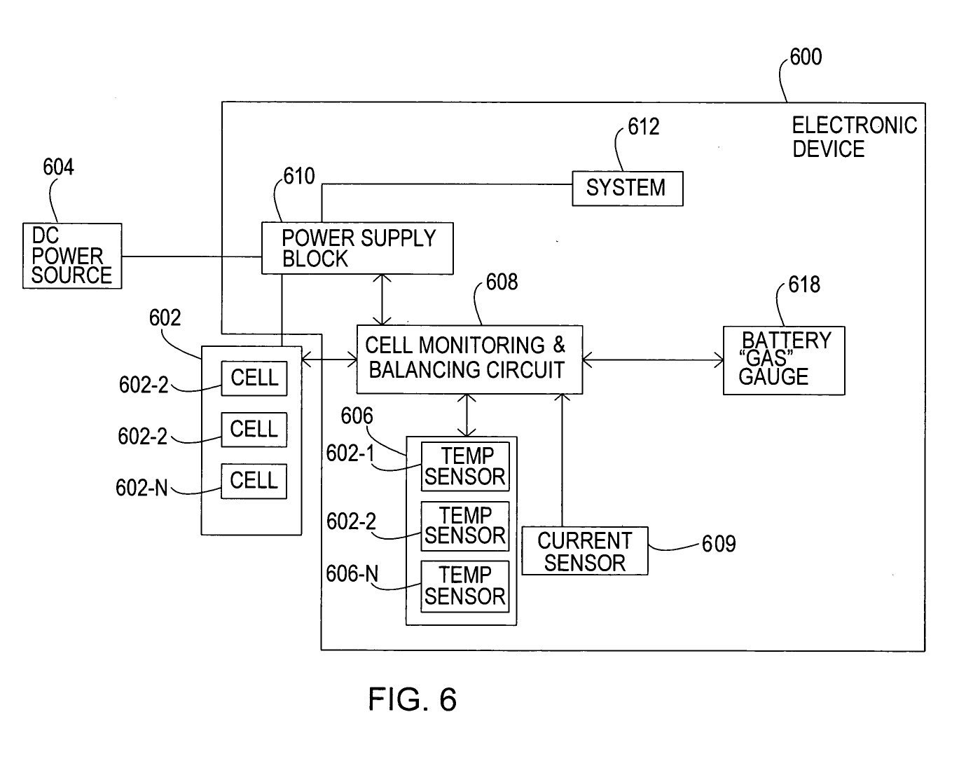

Turning to FIG. 6, an electronic device 600 according to another embodiment of the present invention is illustrated. The electronic device 600 is similar to the electronic device 100 shown in FIG. 1. For clarity, the elements of the electronic device 600 which are similar to the elements of the electronic device 100 will not be described in detail.

The electronic device 600 includes a cell monitoring and balancing circuit 608, a power supply block 610, a system 612 and a battery gas gauge 618. In operation, a battery pack 602 or a DC power source 604 may be coupled to the electronic device 600 for energizing the electronic device 600. The DC power source 604 can also be used to charge the battery pack 602.

For sensing temperature of the individual cells, a temperature sensor group 606 is coupled to the cell monitoring and balancing circuit 608. A current sensor 609 is coupled to the cell monitoring and balancing circuit 608 for sensing current level. The current sensor 609 is configured to generate a digital current signal that is provided to the cell monitoring and balancing circuit 608.

The temperature sensor group 606 comprises a plurality of temperature sensors 606-1-606-n. In one embodiment, the temperature sensors 606-1-606-n can be external temperature sensors. In another embodiment, the temperature sensors 606-1-606-n can be internal built-in temperature sensors.

In accordance with one embodiment of the present invention, the temperature sensor group 606 can be low-power-consuming. Any one of the temperature sensors 606-1, 606-2, 606-n can be powered or energized when temperature is being sampled or sensed. After the temperature has been sampled or sensed, the temperature sensor (e.g., the energized one of 606-1-606-n) that is powered or energized is powered down.

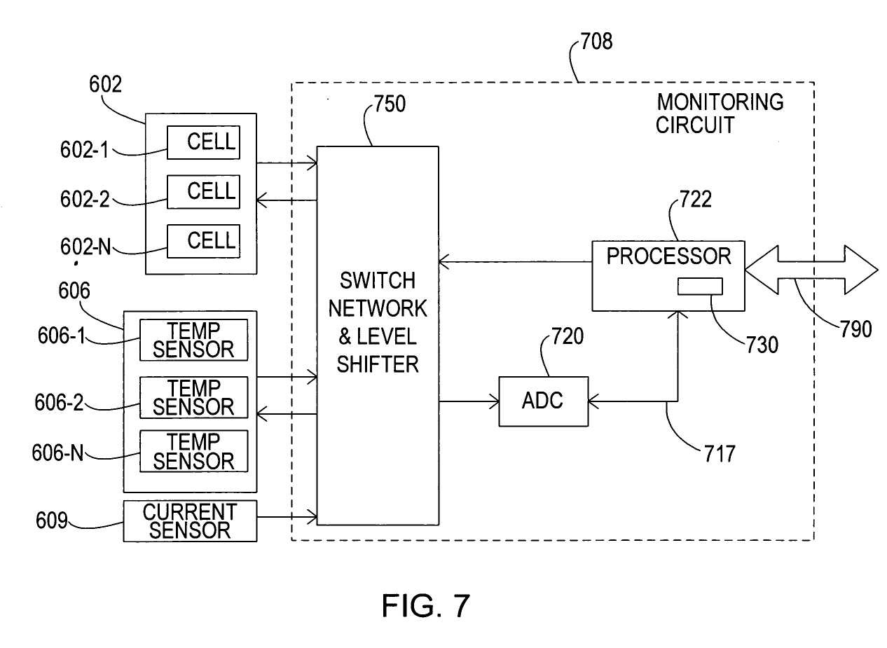

Referring now to FIG.7, a monitoring circuit 708 in accordance with one embodiment of the present invention is illustrated. In one embodiment, a monitoring circuit constituted such as is monitoring circuit 708 shown in FIG. 7 can be used as the cell monitoring and balancing circuit 608 shown in FIG. 6. The monitoring circuit 708 is similar to the monitoring circuit 208 shown in FIG. 2. For clarity, the elements of the monitoring circuit 708 which are similar to the elements of the monitoring circuit 208 will not be described in detail. The monitoring circuit 708 includes a switch network and level shifter 750 adapted to be coupled to the temperature sensors 606-1-606-n, an analog to digital converter (ADC) 720, a processor 722 and the current sensor 609.

An analog voltage signal provided from the current sensor 609 is indicative of the current flowing through the battery pack 602 and is received by the ADC 720 via the switch network and level shifter 750 where it is converted to a digital signal. Besides the analog voltage signal from the battery pack 602 and the current signal from the current sensor 609, the ADC 720 also receives an analog voltage signal from the temperature sensors 606-1-606-n one by one and converts the received voltage signal to a digital signal. According to at least one of the digital signals from the ADC 720, the processor 722 provides a safety alert signal in response to any one of the digital signals from ADC 720.

The switch network and level shifter 750 is utilized to set the switches with the appropriate positions and shift input voltage level so that the voltage signal of each of the battery cells 602-1-602-n, the voltage signal of each of the temperature sensors 606-1-606-n, or the voltage signal of the current sensor can be passed to the ADC 720 and is shifted in the acceptable range of the ADC 720.

In one embodiment, the ADC 720 may function as an “averaging” type ADC and take an “average” reading of the voltage of each battery cell 602-1-602-n and an “average” reading of the voltage signal of each temperature sensor 606-1-606-n, such that transient deviations from normal readings do not adversely impact the quality of the digital signal representation of the analog signal. Moreover, the ADC 720 may also have an adjustable resolution that depends on a particular need or the analog signal sources. For instance, an analog signal from the temperature sensors 606-1-606-n may be converted with a particular conversion by the ADC 720 that is based on their coming from temperature sensors 606-1-606-n.

The processor 722 may provide a safety alert signal during charging or discharging as described in detail described hereinabove. For example, when one of the battery cells 602-1-602-n is larger than the over-voltage threshold for a predetermined period of time, the charging alert signal is triggered. For example, during the charging process, when the charging alert signal is triggered, the charging alert signal acts to disernable the charging process and the charging current drops to zero. Consider the effect of the internal resistance of the battery cell when the charging process is disenabled. In such cases, the voltage drop across the internal resistance of the battery cell will be zero volts, and the voltage across the cell somewhat reduced. In this case, the processor 722 will subtract a predetermined hysteretic value from the over-voltage threshold or the over-voltage threshold will be lowered or reduced so as to keep the alert in an active state. As such, the battery pack 602 can continue to be protected using an appropriate over-voltage threshold and quick switches of the charge alert signal can be avoided.

Moreover, in accordance with one embodiment of the present invention, the over-voltage threshold has a smart hysteretic characteristic that is based on the current flowing through the battery pack 602. In this embodiment, the processor 722 receives the current signal from the current sensor 609 via the ADC 720. The smart hysteretic over-voltage threshold can be calculated in Equation (1) as follows:
Vov=Vov_base+I*Rint (1)
Where Vov is the smart hysteretic over-voltage threshold, Vov_base is a predetermined base over-voltage value which is used in an idle state, I is the current, and Rint is the cell internal resistance. As such, the monitoring circuit 708 according to this embodiment is adapted to establish an over-voltage threshold that is based on the current flowing through the battery pack 602.

Similarly, during a discharging of the battery pack 602, to avoid the quick switches of the discharge alert signal in very short time, the under-voltage threshold may establish a smart hysteretic characteristic that is based on the current flowing through the battery pack 602 during this time.

In one embodiment, the over-voltage and the under-voltage thresholds can be adjusted according to other parameters, such as ambient temperature, which can be obtained from the temperature sensor group 606 via the ADC 720.

During charging or discharging the battery pack 602, the monitoring circuit 708 monitors the temperature level of each of the temperature sensors 606-1-606-n, in order to protect each of the battery cells 602-1-602-n against over-temperature conditions. In one embodiment, an explosion possibility may be avoided, when the temperature of any one of the temperature sensors 606-1-606-n is higher than an over-temperature threshold during the charging or discharging processes. In operation, the processor 722 sends a charging alert signal or a discharging alert signal if the digital signals from the ADC 720 indicate that at least one of the temperature sensors 606-1-606-n has a higher temperature than the over-temperature threshold for a predetermined period of time. In response to the charging alert signal or the discharging alert signal, the charging process or discharging process may be stopped. In one embodiment, to avoid quick switches, the monitoring circuit 708 can also provide over-temperature protection, where the over-temperature threshold has the hysteretic characteristic.

Similarly, it is dangerous for the battery pack 602 if any one of the temperatures of the battery cells 602-1-602-n becomes too low during the charging or discharging process. When at least one of the temperature sensors has a temperature level less than an under-temperature threshold for a predetermined period of time, the processor 722 may send out an alert signal.

A sampling time interval can be adjusted by the processor 722. Within the sampling time interval, the temperature sensors 606-1-606-n, and the current sensor 609 may be sampled once and a valid digital conversion may be made by the ADC 220 for the current sensor 609 and each of the temperature sensors 606-1-606-n.

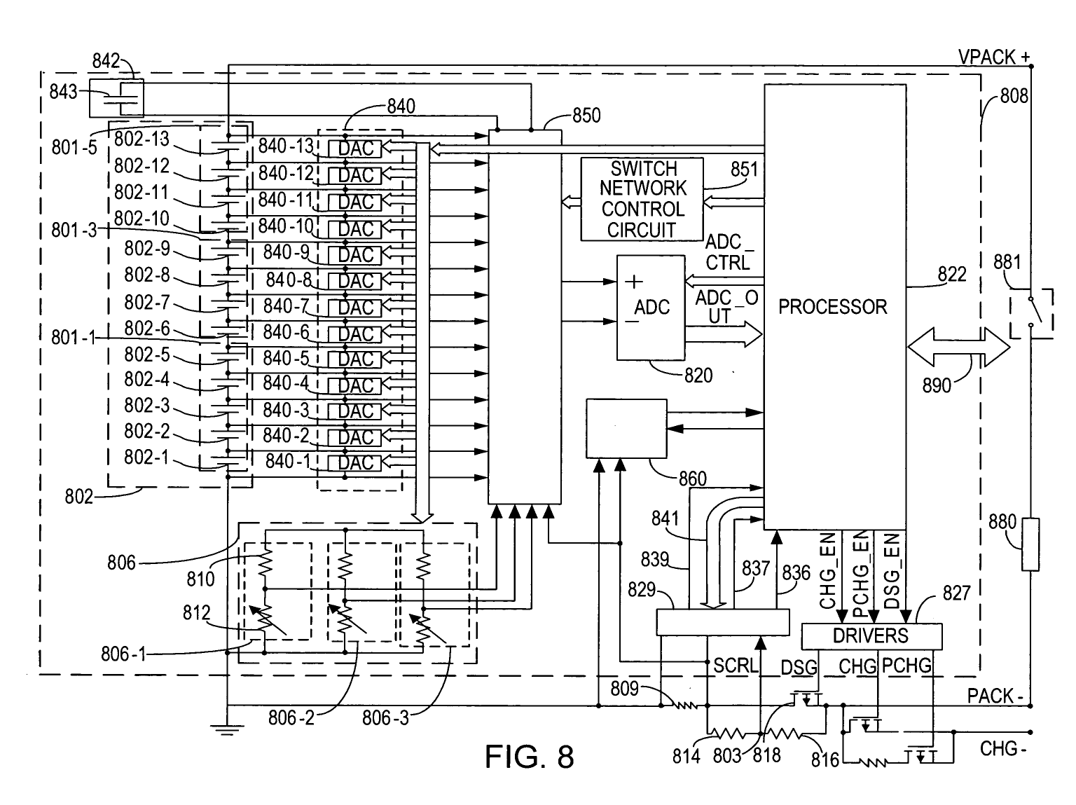

Turning to FIG. 8, a cell monitoring and balancing circuit 808 according to one embodiment of the present invention is illustrated. The cell monitoring and balancing circuit 808 is similar to the balancing circuit 308 shown in FIG. 3. For purposes of clarity and brevity, the elements of the cell monitoring and balancing circuit 808 which are similar to the elements of the electronic device 400 shown in FIG. 4 will not be described with reference to FIG. 8 in detail. The circuit 808 according to one embodiment of the present invention comprises an ADC 820, a processor 822, a switch network control circuit 851, a switch network and level shifter circuit 850, a bleeding network circuit 840, a driver circuit 827, a protection circuit 829, a current sensor 809, and a temperature sensor group 806.

Referring to FIG. 8, the battery pack 802 comprises battery cells 802-1, 802-2, 802-3, 802-4, 802-5, 802-6, 802-7, 802-8, 802-9, 802-10, 802-11, 802-12, and 802-13. Individual analog voltage levels for each cell of the battery pack 802 can be sampled directly through the switch network and level shifter circuit 850. The sampled analog signals then are converted into associated digital signals by the ADC 820 as previously detailed. For example, when the first cell 802-1 is to be sampled, the positive terminal of the first cell 802-1 is coupled to the positive input terminal of the ADC 820 and the negative terminal of the first cell 802-1 is coupled to the negative input terminal of the ADC 820. All switches of the switch network and level shifter circuit 850 will remain in these positions until a valid analog to digital conversion is completed by the ADC 820.

The temperature sensor group 806 is used to sense the temperature of different places. For example, in one embodiment, the first temperature sensor 806-1 can be used to sense the temperature of the battery cell 802-1. The first temperature sensor 806-1 includes resistors 810 and 812. The resistor 810 is a fixed-value resistor, and the resistor 812 is a thermal-resistor. The resistance of the thermal-resistor 812 may change according to the temperature-resistance curve. Moreover, the voltage between the resistor 810 and the resistor 812 may be changed. The changed voltage may be converted by the ADC 820 and sent to the processor 822. Once the voltage is detected, the resistance of the resistor 812 is calculated using ohm's law. Based on the temperature-resistance curve, the corresponding temperature is calculated.

Additionally, the voltage across the current sensor 809 can be directly coupled to the ADC 820 for directly sampling the current signal of the current sensor 809 or sampling the current flowing through the current sensor 809.

The charge shuttling circuit 842 includes an energy storage element, such as a transformer, inductor, or capacitor. In the illustrated embodiment, a capacitor 843 is utilized as the energy storage element. If charge shuttling among cells is directed by the processor 822, the appropriate switches of the switch network and level shifter 850 direct charges from one or more of the cells with a higher voltage to be temporarily stored in the capacitor 843. Such charges are then shuttled to a lower voltage cell by the appropriate switches of the switch network. The processor 822 controls the switch network and level shifter 850 via the switch network control circuit 851.

The ADC 820 according to one embodiment of the present invention can also be calibrated for each cell group 801-1, 801-3, and 801-5 in order to compensate for any offset. In the FIG. 8 embodiment, the cell group 801-1 includes the cells 802-1, 802-2, 802-3, 802-4, 802-5; the group 801-3 includes the cells 802-6, 802-7, 802-8, 802-9; the group 801-5 includes the cells 802-10, 802-11, 802-12, 802-13. Such offset can be due to any number of factors such as different voltage gradients, and switching charge injection for different ADC cell channels. For instance, to calibrate the first cell group 801-1, by means of the switch network and level shifter circuit 850, the input terminals of the ADC 820 are coupled to the virtual ground of the cell group 801-1. The ADC 820 may then convert such analog signal into an associated first offset digital signal. The first offset digital signal may then be stored in any available memory device.

Similarly, the cell group 801-3 and 801-5 can be calibrated. In one embodiment, three offset values for each cell group can be obtained and stored. The offset value of the cell group 801-1 is for the cells in the group 801-1; the offset value of the cell group 801-3 is for the cells in the group 801-3; and the offset value of the cell group 801-5 is for the cells in the group 801-5. When the ADC 820 is subsequently converting an analog measurement for an associated cell, the processor 822 can instruct acquisition of offset-free data by subtracting the stored associated offset value for the associated group. As such, accurate measurement of the analog signal from each cell is further accommodated.

Further, the ADC 820 according to one embodiment of the present invention can further be calibrated for the temperature sensor group 806 in order to compensate for any offset of the temperature sensor group 806. For instance, to calibrate the temperature sensor group 806, by means of the switch network and level shifter circuit 850, the positive input terminal of the ADC 820 firstly is connected to a first reference voltage, Vr1, not shown, such as 1.05 volt, and the negative input terminal of the ADC 820 is connected to the ground. The ADC 820 converts such analog signal to a first digital signal D1. Secondly, the positive input terminal of the ADC 820 is connected to a second reference voltage, Vr2, not shown, such as 2.10 volt, (i.e., Vr2=2*Vr1) and the negative input terminal of the ADC 820 is connected to the ground. The ADC 820 converts such analog signal into a second digital signal D2. The processor 822 calculates the difference between twice the first digital signal and the second digital signal (2*D1−D2) as the temperature sensor offset digital signal and stores it in the memory. When the ADC 820 is subsequently converting an analog measurement from the temperature sensors, the processor 822 can instruct acquisition of offset-free data by subtracting the stored offset value. As such, accurate measurement of the analog signal from the temperature sensor group 806 is further accommodated.

A protection circuit 829 can also be incorporated into the cell balance and monitoring circuit 808 in order to monitor the current flowing into (charging mode) or out of (discharging mode) the battery pack 802 for various power crisis conditions, e.g., over current or short circuit conditions, and alert the processor 822 of such conditions so that preventative action can be taken. For example, a current sensor 809 can be coupled to the battery pack 802 to provide the protection circuit 829 with a signal representative of the current level flowing through the battery pack 802. If the current level is greater than a first current threshold level, (e.g., the voltage drop across the current sensor 809 is greater than the first current threshold level times the value of the sense resistor), then the protection circuit 829 may provide an over-current alert signal to the processor 822 via data path 837.

The current level may be greater than a second current threshold level, where the second current threshold level is greater than the first current threshold level. In this instance, the protection circuit 829 provides a short circuit alert signal to the processor via data path 839.

If the processor 822 detects that the over-current alert signal is active for a predetermined period of time, the processor 822 may generate the charge alert signal and the discharge alert signal to stop the charge process and the discharge process, respectively. Once the processor 822 generates the charge alert signal or the discharge alert signal due to the over current alert signal or the short circuit alert signal, the charge alert signal and the discharge alert signal may be kept active until the over-current alert signal or the short circuit signal is released. There are two methods for release of the over-current alert signal or the short circuit signal: the time release method, and the external release method.

If the time release method is used, the charge alert signal and the discharge alert signal may be kept active for a predetermined release period of time. The predetermined release period of time is adjusted by setting the corresponding data stored in the memory. After that, the charge alert signal and the discharge alert signal are released to be inactive.

On the other hand, if the external release method is used, the charge alert signal and the discharge alert signal may be kept active until the external release signal is active. It is noted that in the charging process, even the external release method is used, the charge alert signal may be kept active for a period of time.

In accordance with one embodiment of the present invention, two resistor 814, 816, the resistances of which may be very large and can be up to several million Ohms, and the protection circuit 829 are used to generate the external release signal. The resistors 814 and 816 are coupled to a MOSFET 818 in parallel so as to form a bypass. For example, during the discharge process, the battery pack 802 supplies power to a load 880 and an external switch 881 is coupled to the load 880 in series. When the discharge alert signal is active due to the over-current alert signal or the short circuit alert signal, the MOSFET 818 may be opened to stop the discharge process. At this time, a bypass current may still flow though the resistors 814 and 816. Because the resistance of the load 880 and the resistance of the current sensor 809 are much smaller than the resistance of the resistors 814 and 816, the voltage (VSCRL) at the node 803 can be calculated in Equation (2) as follows:
V_{SCRL}=V_{pack}*R1/(R1+R2)

Where V_{pack} is the voltage of the battery pack 802, R1 is the resistance of the resistor 814, and R2 is the resistance of the resistor 816.

In this circumstance, if the external switch 881 is opened, the current loop is open and the voltage at the node 803 is about 0 volt. In the protection circuit 829, a comparator, not shown, has a preset voltage, which is between 0 volt and V_{SCRL}. The output of the comparator is transmitted to the processor 822 via the data path 836. If the voltage at the node 803 is larger the preset voltage, the external switch 881 is not open and the output of the comparator is “0” which indicates the external release signal is inactive. In one embodiment, the discharge alert signal is still active and the MOSFET 818 may be kept in an open state. Once the external switch 881 is open, the voltage at the node 803 is about 0 volts and is lower than the preset voltage. In this circumstance, the output of the comparator will be 1 so as to indicate that the external release signal is active. Thus, the discharge alert signal will be turned to be inactive and the MOSFET 818 will be enabled.

In response to the charge alert signal and the discharge alert signal, the processor 822 can send appropriate control signals to a host component, not shown, via data path 890 such that some alternative component, e.g., a power management unit, may manage any necessary corrective action to ensure power supply safety.

The bleeding network circuit 840 may include a plurality of bleeding circuits 840-1, 840-2, 840-3, 840-4, 840-5, 840-6, 840-7, 840-8, 840-9, 840-10, 840-11, 840-12 and 840-13 to provide an adjustable bleeding current to each associated cell 802-1, 802-2, 802-3, and 804-4 as previously detailed.

A wakeup circuit 860 according to one embodiment of the present invention is employed to generate a wakeup signal when the cell monitoring and balancing circuit 808 is in an idle mode or a sleep mode. The processor 822 controls the cell monitoring and balancing circuit 808 running in a full power mode, idle mode or sleep mode. If there is no over temperature event, no under temperature event, no over current event, no short circuit event and the battery pack 802 is not in charge mode, not in discharge mode during some period of time, the processor 822 will make the cell monitoring and balancing circuit 808 into the idle mode or sleep mode in which the cell monitoring and balancing circuit 808 and the bleeding circuit 860 is disabled to save power.

The wakeup circuit 860 comprises an offset-free integrator and a comparator (both not shown). The integrator is used to sample the voltage across the current sensor 809 and output a digital signal to the comparator for comparing the integrator's output digital signal with a built-in threshold. If the integrator's output is greater than the built-in threshold of the comparator, the wakeup signal is generated and transmitted to the processor 822. The cell monitoring and balancing circuit 808 will run in full power mode from the sleep mode once the active wakeup signal is detected.

Additionally, a pulse signal 861 controlled by the processor 822 is used to control the integrator's output digital signal and make sure the signal is non-negative whether or not the input voltage of wakeup circuit is positive or negative, or no matter the cell pack 802 is charged or discharged. Furthermore, the width of the pulse signal 861 is used to adjust the built-in threshold of the comparator, the wider the pulse width, the lower the threshold. The pulse width of the pulse signal 861 is adjusted by setting the corresponding data stored in any available memory.

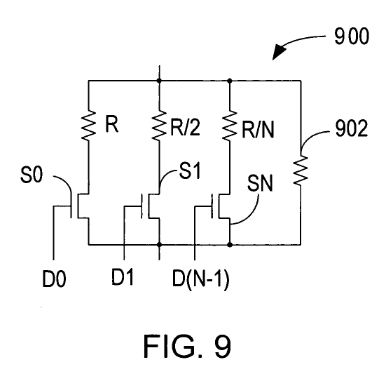

Turning to FIG. 9, a bleeding circuit 900 according to one embodiment of the present invention utilized in the bleeding network circuit of FIG. 8 is illustrated. For clarity, the elements of the bleeding circuit 900 which are similar to the elements of the bleeding circuit 500 will not be described in detail with reference to FIG. 5.

The bleeding circuit 900 as shown in FIG. 9 comprises an additional bias resistor 902 which is used to detect the disconnection between the battery cell's terminal and an external pin of the processor 822. In one embodiment, the resistance of the bias resistor 902 is large and up to several million ohms. As described hereinbefore, the bleeding circuit 900 is coupled to an associated battery cell. In one situation, the processor 822 instructs all switches S0, S1 . . . SN to close, such that a small resistance (i.e., resistors that include the resistor 902 are coupled to each other in parallel) is coupled in parallel with the associated cell. In one embodiment, a first voltage across the associated battery cell will be measured. In another situation, the processor 822 instructs all switches S0, S1 . . . SN to open, such that a large resistance, i.e., the resistor 902, is coupled in parallel with the associated cell. A second voltage across the associated battery cell will be measured. Since the bleeding circuit 900 is coupled in parallel with the associated battery cell, the circuit 900 can be considered as an internal resistance of the associate battery cell, and the two measured voltages will be different. In practice, by comparing the difference of the two measured voltages with the predetermined disconnection threshold which can be adjusted by the processor 822, a disconnection can be detected if the difference is greater than the disconnection threshold. Thus, the processor 822 as shown in FIG.8 will provide a disconnection alert signal indicating that there is a corresponding disconnection between the battery cell's terminal and the external pin of the processor 822.

Furthermore, the circuit 900 can provide a protection function of the reverse of the battery cell. If any one of battery cells is assembled in a reverse direction, a negative voltage on the bias resistor 902 can be detected and a reverse alert signal will be generated to indicate that the corresponding cell is in a reverse direction. Furthermore, since the resistor 902 in the bleeding circuit 900 is very large, it will limit the current through the battery pack 802 shown in FIG. 8. Thus, the battery pack 802 is protected against the damage due to the cell reverse.

In the above detailed description of the present invention, numerous specific details are set forth in order to provide a thorough understanding of the present invention. However, it will be appreciated by one of ordinary skill in the art that the present invention may be practiced without these specific details. In other instances, well known methods, procedures, components, and circuits have not been described in detail as not to unnecessarily obscure aspects of the present invention.

What is claimed is:

1. A monitoring circuit for monitoring a plurality of battery cells of a battery pack, comprising:
a plurality of temperature sensors for sensing temperatures of said plurality of battery cells and outputting a plurality of analog temperature voltage signals representative of said temperature of said plurality of battery cells;
an analog to digital converter (ADC) adapted to receive said plurality of analog temperature voltage signals and to convert each of said plurality of analog temperature voltage signals to a individual digital signal; and
a processor adapted to generate an alert signal when said individual digital signal is not within a predetermined range.

2. The monitoring circuit of claim 1, further comprising:
a current sensor coupled to said battery pack for sensing a current level associated with said battery pack wherein said processor generates said alert signal if said current level is greater than an over-current threshold.

3. The monitoring circuit of claim 1, wherein said predetermined range is defined with an over temperature threshold and an under temperature threshold.

4. The monitoring circuit of claim 3, wherein said over temperature threshold is adjustable.

5. The monitoring circuit of claim 1, wherein said ADC is further adapted to receive a plurality of cell voltage analog signals from said plurality of battery cells and to output a plurality of cell voltage digital signals representative of voltages of said plurality of battery cells.

6. The monitoring circuit of claim 5, wherein said processor is further adapted to generate said alert signal if said plurality of cell voltage digital signals is not within a predetermined voltage range.

7. The monitoring circuit of claim 6, wherein said predetermined voltage range is defined with an over voltage threshold and an under voltage threshold.

8. The monitoring circuit of claim 7, wherein said over voltage threshold is reduced by a predetermined hysteretic value when said alert signal is generated.

9. The monitoring circuit of claim 8, wherein said predetermined hysteretic value is related to a current flowing through said battery pack.

10. The monitoring circuit of claim 7, wherein said under voltage threshold level is adjustable.

11. The monitoring circuit of claim 1, further comprising a switch network for individually coupling said plurality of temperature sensors to said ADC.

12. The monitoring circuit of claim 11, wherein said switch network is further adapted to individually couple said plurality of battery cells to said ADC and said ADC has a positive input terminal and a negative input terminal, wherein said positive input terminal and said negative input terminal are coupled to a virtual ground of one of said plurality of battery cells to generate an offset signal so as to calibrate said ADC.

13. The monitoring circuit of claim 11, wherein said switch network further comprises a plurality of switches controlled by said processor so as to individually couple said plurality of battery cells to said ADC

14. An electronic device capable of energizing a load using a battery pack having a plurality of battery cells, said electronic device comprising:
a plurality of temperature sensors for sensing temperatures of said plurality of battery cells and outputting a plurality of analog temperature voltage signals representative of said temperature of said plurality of battery cells;
an analog to digital converter (ADC) adapted to receive said plurality of analog temperature voltage signals and to convert each of said plurality of analog temperature voltage signals to a individual digital signal; and
a processor adapted to generate an alert signal in order to disable a charging or discharging of said battery pack when said individual digital signal is not within a predetermined range.

15. The electronic device of claim 14, further comprising:
a current sensor coupled to said battery pack for sensing a current level associated with said battery pack wherein said processor generates said alert signal if said current level is greater than an over-current threshold.

16. The electronic device of claim 14, wherein said predetermined range is defined by an over temperature threshold and an under temperature threshold.

17. The electronic device of claim 16, wherein said over temperature threshold is adjustable.

18. The electronic device of claim 14, wherein said ADC is further adapted to receive a plurality of cell voltage analog signals from said plurality of battery cells and to output a plurality of cell voltage digital signals representative of voltages of said plurality of battery cells.

19. The electronic device of claim 18, wherein said processor is further adapted to generate said alert signal if said plurality of cell voltage digital signals is not within a predetermined voltage range.

20. The electronic device of claim 19, wherein said predetermined voltage range is defined by an over voltage threshold and an under voltage threshold.

21. The electronic device of claim 20, wherein said over voltage threshold is reduced by a predetermined hysteretic value when said alert signal is generated.

22. The electronic device of claim 21, wherein said predetermined hysteretic value is related to a current flowing through said battery pack.

23. The electronic device of claim 20, wherein said under voltage threshold level is adjustable.

24. The electronic device of claim 14, further comprising a switch network for individually coupling said plurality of temperature sensors to said ADC.

25. The electronic device of claim 24, wherein said switch network is further adapted to individually couple said plurality of battery cells to said ADC and said ADC has a positive input terminal and a negative input terminal, wherein said positive input terminal and said negative input terminal are coupled to a virtual ground of one of said plurality of battery cells to generate an offset signal so as to calibrate said ADC.

26. The electronic device of claim 24, wherein said switch network further comprises a plurality of switches controlled by said processor so as to individually couple said plurality of battery cells to said ADC.
